(19) United States
(12) Patent Application Publication
(10) Pub. No.: US 2012/0203944 A1
(43) Pub. Date: Aug. 9, 2012

(54) Systems and Methods for Providing Access to Financial Trading Services

(75) Inventors: Matthew Otto, Roselle, IL (US); Joseph Weitekamp, Malverne, NY (US)

(73) Assignee: ITG SOFTWARE SOLUTIONS, INC., Culver City, CA (US)

(21) Appl. No.: 13/022,420

(22) Filed: Feb. 7, 2011

(51) Int. Cl. G06F 13/00

(52) U.S. Cl. 710/107

(57) ABSTRACT

A system and method to allow service consumers to access financial services deployed using various integration technologies with optimal latency through a technique of data-driven bus arbitration and the use of on-demand delivered bus integration plug-in components.

### BACKGROUND OF THE INVENTION

1. Field of Invention

The invention generally relates to systems and methods for providing electronic access to financial trading services and, more particularly, to systems and methods for providing access to financial trading services via electronic networks through the use of multiple service buses that can be individually configured to optimize access to financial trading services of diverse technical implementations without the need for bridging.

2. Discussion of the Background

Speed and reliability are of paramount importance in the financial trading services industry. A failure on the part of a provider to deliver trading services at acceptable levels of speed and/or reliability to its customers can potentially result in significant financial losses. Thus, the financial trading services industry is constantly examining potential infrastructure improvements to improve the speed and reliability of financial services. For example, a trader wishing to place a buy order for a large quantity of shares of a security may utilize a trading algorithm that relies on the latest prices in order to execute the order within acceptable price limits. If the price information utilized by the algorithm is delayed there is an increased likelihood that the price information has changed and the algorithm is not aware of the actual current market price of the security. In a situation where the trade being executed involves a large quantity of shares, even a small price change can have significant impact on the profits and losses incurred by traders and their clients. Therefore, traders demand that the financial trading services they access be appropriately designed and deployed to allow fast and reliable access.

Through the use of proprietary messaging techniques the financial industry has improved the speed and reliability of its networks and services. SOA is a way to organize distributed computing resources across enterprise systems. Systems arranged according to SOA techniques are generally composed of relatively independent active software-based computing agents or services that provide a set of business functionality. A business process is then implemented by coordinating the use of a specified set of services. Services are accessed through well-defined interfaces implemented using a single standardized technology, set of protocols, and data model. This standardization allows technologically heterogeneous services to be accessed without a user having to account for the differences in the implementation technologies. Thus, service consumers know only of the standardized interface, to which they are exposed, and the semantic operations the services provided. Unfortunately, systems arranged according to SOA techniques are often slower due to increased levels of overhead resulting from the SOA computer architecture. This often precludes the use of SOA techniques in time sensitive applications, such as financial trading.

A service bus is the infrastructural component of a SOA that allows service consumers and services to electronically communicate. Service consumers and services electronically communicate by exchanging electronic messages. There are several service bus technologies that can be utilized within a SOA framework. For example, a service bus can be implemented through the use of message broker technology. Message broker technology utilizes a central intermediary that receives and routes all messages to be exchanged between the service consumers and the services. Examples of message broker technologies include: available retail and proprietary middle-ware packages, such as TIBCO EMS, Microsoft MSMQ, and IBM WebSphere MQ.

By distributing financial trading services via a SOA model, traders are presented with one point of interaction from which multiple financial services can be accessed. These services can be developed as part of a financial service package or can have been individually selected and deployed. Thus, through the use of SOA, financial service networks have increased flexibility as to what services are offered to its clients.

SOA implementations are commonly implemented using a single common service bus. In these implementations, a service consumer accesses all available services through the use of a single service bus. However, there are situations when at least one service to be accessed via the service bus is not accessible via the implemented service bus technology. This situation often occurs when a manufacturer dictates that a service only be made available via a particular technology. This may be the case when a common SOA communication technology cannot provide the performance required by the service and its consumers, or when a legacy service must be incorporated into a more modern architecture. For example, while a financial network might continuously upgrade its market data feed services, the same company might be hesitant to change the service it uses to perform trade order clearance. This might be the case because while market data feed services are important, they are not necessarily mission critical. That is, a small error in the market data feed service might lead to inconvenience and potentially a larger problem, but a small error in a trade order clearance service could easily have severe ramifications. For this reason, financial service providers might retain legacy systems that, while very important, are not compatible with its other financial service offerings.

To accommodate legacy systems with disparate services, an SOA may be implemented using multiple service buses. In these types of implementations, it is common practice to allow a service consumer to access the multiple service buses via one of the service buses. For example, in a SOA having service buses A and B, a service consumer accesses service bus A, which in turn accesses service bus B.

One way in which electronic communication is implemented between service buses A and B is through the use of a bridge. A bridge translates the messages and protocols of one service bus (e.g., service bus A) into a form usable by another heterogeneous service bus (e.g., service bus B) and vice versa. This technological approach can provide functionally seamless access to a service on a secondary service bus by a service consumer in direct communication to the primary service bus. This approach is illustrated in system 100 of FIG. 1.

According to FIG. 1, service X 106 is accessible via service bus A 104, and service Y 112 is accessible via service bus B 110. As shown in FIG. 1, service consumer 102 has direct access to service bus A 104. Thus, if service consumer 102 wants to access service X 106, a message must be routed through service bus A 104. Likewise, if service consumer 102 wants to access service Y 112, a message must be routed through service bus B 110. However, because the service consumer 102 can only directly access service bus A 104, it is necessary that service bus A 104 be able to communicate a message to service bus B 110. Bridge 108 serves as a message translator and intermediary to facilitate communication between the disparate messaging protocols of service bus A 104 and service bus B 110. In keeping with general computer architecture shown in FIG. 1, and described in detail above, services X 106 and Y 112 could be market data feed and trade order clearance services.

One deficiency of the approach illustrated in FIG. 1 is that it introduces additional latency into the system. More particularly, messages originating at a service on the primary bus must be routed at minimum two times. First, a message is routed from service consumer 102 through service bus A 104 to bridge 108. Second, the message is routed from bridge 108 through service bus B 110 to service Y 112. Thus, there are four separate communication segments that must be traversed in order to allow service consumer 102 to access service Y 112. In many applications this cost is quite tolerable. However, in sensitive applications (e.g., security trading systems) the additional latency can disrupt the system such that the inferior results can lead to unacceptable outcomes. For example, if service Y 112 was a market data feed service, the additional latency resulting from the inferior network architecture could lead to situations where the information being acted on by trading clients was inaccurate.

Thus, there is a need in the field for improved systems and methods for optimizing access to financial trading services.

### SUMMARY OF THE INVENTION

The present invention overcomes disadvantages of the prior art and improves access to financial trading services via electronic networks through the use of multiple service buses that can be individually configured to optimize access to financial trading services of diverse technical implementations without bridging.

In accordance with a first aspect of the present invention, a computer-implemented method provides access to financial trading services by identifying financial trading services that will be accessible to an end user and determining performance requirements for each financial trading service. The performance requirements relate to at least one of latency and reliability for each financial trading service. The method also includes creating, by a computer, at least a first service bus and a second service bus, wherein the first and second service buses have performance characteristics related to at least one of latency and reliability, and wherein a performance characteristic of the first service bus differs from a performance characteristic of the second service bus. In addition, the method includes determining a first group of financial trading services that will be accessible via the first service bus and a second group of financial trading services will be accessible via the second service bus. Further, the method includes attaching, by the computer, the first group of financial trading services to the first service bus and the second group of financial trading services to the second service bus.

In accordance with a second aspect of the present invention, a method for accessing financial trading services includes receiving, by a computer, a first financial trading service request message via a first service bus with a first performance characteristic and a second financial trading service request message via a second service bus with a second performance characteristic that differs from the first performance characteristic. The first and second financial trading service request messages are generated by a financial trading service consumer and routed to appropriate services via an interface component. In addition, the method includes sending, by the computer, the received first financial trading service request message to a first financial trading service that is connected to the first service bus and the received second financial trading service request message to a second financial trading service that is connected to the second service bus.

In accordance with a third aspect of the present invention, a computerized system for accessing financial trading services includes a first and second plurality of financial trading services attached to first and second service buses configured to receive financial trading service request messages. The first plurality of financial trading services are attached to the first service bus and the second plurality of financial trading services are attached to the second service bus. The first and second service buses have performance characteristics related to at least one of latency and reliability, and a performance characteristic of the first service bus differs from a performance characteristic of the second service bus. The received financial trading service request messages are routed by an integration component configured to route the financial trading service request messages to one of the first and second service buses.

### BRIEF DESCRIPTION OF THE DRAWINGS

The above and other objects and advantages of the present invention will become more readily apparent upon consideration of the following detailed description, taken in conjunction with accompanying drawings, in which like reference characters refer to like parts throughout the drawings and in which:

FIG. 1 is a block diagram of a prior art financial services delivery system with bridged message buses;

FIG. 2 is a block diagram of an exemplary direct access multiple bus system according to the present invention;

FIG. 3 is a detailed block diagram of an exemplary direct access multiple bus system according to the present invention; and

FIG. 4 is a unified modeling language sequence diagram showing the operation of an exemplary direct access multiple bus system according to the present invention.

### DETAILED DESCRIPTION OF THE INVENTION

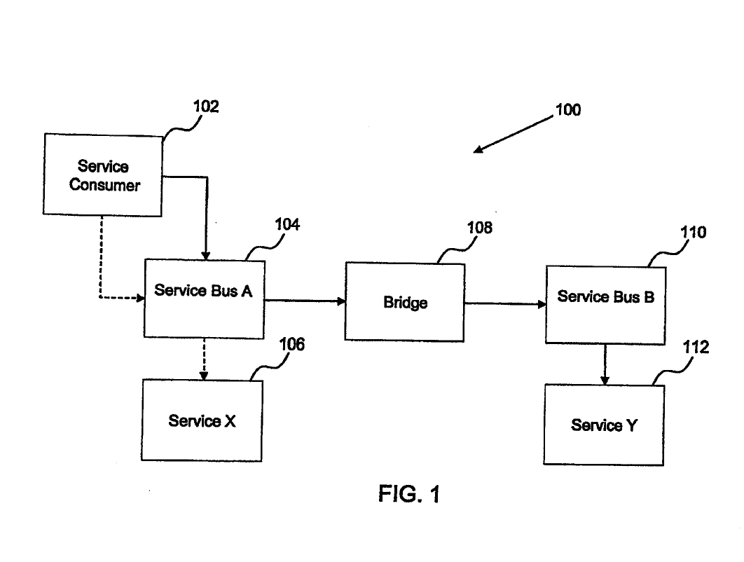

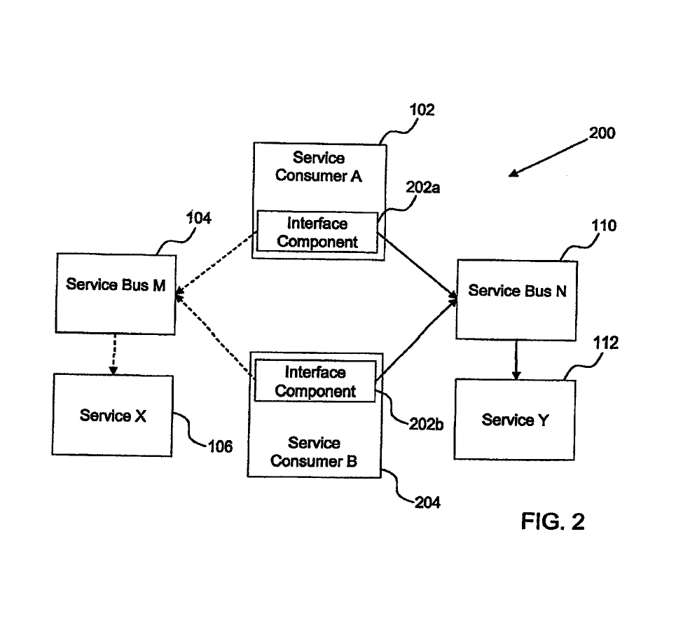

As discussed above with regard to FIG. 1, the use of bridged heterogeneous service buses leads to inefficiencies and latency. The present invention solves this problem by providing multiple buses by which services can be directly accessed by service consumers. An example of a direct access multiple bus system according to the present invention is illustrated in FIG. 2 at 200.

As shown in FIG. 2, the system 200 is a multiple bus SOA in which service consumer A 102 and service consumer B 204 each have direct access to service bus M 104 and service bus N 110, from which services X 106 and Y 112 are respectively available. This access is mediated by interface components 202a and 202b. Because service consumers A 102 and B 204 have direct access to service buses M 104 and N 110, there is no need for the service buses to be connected via a bridge. That is, each service consumer 102, 204 can access each service bus 104, 110 and each service 106, 112 connected to a respective bus. The interface components 202a and 202b integrate and communicate directly with multiple service buses (utilizing either homogeneous or heterogeneous service bus protocols/technologies). Additionally, the interface components 202a and 202b route the various service requests being made by the service consumers 102 and 204 to the appropriate service bus, based on which service is being accessed. In order to accomplish the proper routing of messages, the interface components 202a and 202b can access information defining which service buses host which services.

For example, the interface components can be coded to include the routing rules. However, this hard coding of the routing rules permanently fixes services to the service buses to which they are assigned, and fails to allow for the addition of new services. Thus, if the routing rules are to be changed in any way new versions of the interface components would have to be coded.

According to one embodiment of the present invention services are allowed to be freely deployed on any service bus in the enterprise at any time. These services can be found using an interface component that is connected to a service directory. The service directory can be stored in a database that is in electronic communication with the interface components. The service directory stores bus identification information cross-referenced with the available services in a directory that is accessible by the interface components. This directory information is allows the interface component to make routing decisions. Additionally, Data describing the bus' technology, including the bus driver component mentioned earlier is also registered, allowing the free migration of services between buses using different communication technologies.

The implementation shown in FIG. 2 reduces the latency of the system by removing two of the communication segments between the service consumers A 102 and B 204 while maintaining access to both services X 106 and Y 112. That is, there are only two separate communication segments that must be traversed in order to allow service consumers A 102 and B 204 to access both services X 106 and Y 112. For example, a message is sent from service consumer A 102 to service bus N 110 (first segment), where it is routed and sent to service Y 112 (second segment).

According to one embodiment of the present invention, service buses M 104 and N 110 are heterogeneous, i.e., the service buses are implemented using different technologies. According to another embodiment of the present invention, service buses M 104 and N 110 are homogonous, i.e., the service buses are implemented using the same technology. According to another embodiment of the present invention, homogonous service buses that are connected to the same services can be implemented in a load balancing configuration. By dividing the message traffic across two or more service buses, latency can be improved.

Examples of service bus technologies include, but are not limited to: broker-mediated service buses; broker-mediated service buses with persistent data storage; and peer-to-peer (P2P). Each of these technologies has strengths and weaknesses.

In a broker-mediated service bus the broker receives a message destined for a service and routes the message accordingly. This technology offers a low cost service bus solution. However, this solution is not appropriate for all types of services. For example, this service bus technology does not guarantee delivery of the message to the destination service. That is, if there is an error, the message is lost and delivery does not take place. Thus, this technology is most appropriate for services that are not mission critical. For example, in the financial trading industry there are trade analytics services that are used to help traders make optimal trading decisions. These analytics, while important, are not necessarily mission critical. Thus, if a trader requests the analytic service and the trader fails to receive the requested service, there will not necessarily be profound negative impact on the trader. So, in some embodiments, a broker-mediated bus service could be appropriate for accessing trade analytics services and the like (although other service bus technologies could be used for such services if a broker-mediated bus is not available).

In a broker-mediated service bus with persistent data storage the broker receives a message, stores a copy of the message, routes the message accordingly, and re-routes the message again if delivery of the first message fails. This technology is more expensive than the simple broker-mediated service bus, due at least in part to the cost of the data storage and memory hardware. Additionally, because there is the additional step of creating a storing a copy of each message, the broker-mediated service bus with persistent data storage is slower than the simpler broker-mediated service bus. However, this increase in latency is acceptable for mission critical services.

For example, in the financial trading industry, messages that contain trade clearance information are mission critical. That is, if a trade is executed and the trade is not cleared within the appropriate period of time, there will be profound negative implications. Thus, the use of a service bus that guarantees message delivery is preferred with the use of this service. Moreover, the higher latency associated with this technology is not a problem when it comes to trade clearance services.

Another example of a service for which this technology is appropriate is the sending of trade orders. That is messages that contain trade orders being sent to electronic trade destinations are mission critical. That is, the negative impact of the trade message not being delivered to the appropriate service could be profound. Thus, the use of a service bus that guarantees message delivery is preferred with the use of this service. Additionally, while this technology is one of the slower message bus technologies, there are modifications that can be used to minimize the increase in latency. For example, the hardware running the message bus software can be optimized through the use of faster components, increased memory, and/or dedicated hardware acceleration. Moreover, the geographic placement of the hardware running the service bus can be optimized to reduce latency. These modifications can be applied to any service bus technology described herein to improve performance and lower latency.

In a P2P service bus there is no broker that mediates the message delivery. Additionally, there is no persistent storage of the messages. Rather, messages are sent directly from a service consumer to a service without additional routing. P2P is the fastest of the service bus technologies described herein. Lacking a central point of control, P2P is the least easily manageable of the described service buses. It also burdens the sending system with the responsibilities of the broker in a broker model, which can result in inferior performance when many copies of the same message must be sent to many recipients. This technology is appropriate for access to services that require low latency and are not mission critical. For example, in the financial trading industry, market data is relayed via feeds to traders' workstations. In a SOA system implementation, these data feeds consist of a steady stream of messages which are snapshots of market information at a particular time. By minimizing the latency of these messages, traders are provided with the most accurate and up-to-date market information. This is imperative because even a small price shift can have tremendous ramifications for traders, especially block traders that consistently execute trades of several hundred thousand shares. Additionally, because these feeds are constant, if a message fails to be properly delivered, the next message in the stream will remedy the situation.

According to an embodiment of the present invention, a SOA implemented system can have multiple service buses, that are either homo- or heterogeneous, which are optimized for different purposes and services. For example, within one SOA implementation, one service bus could be optimized for low latency (i.e., speed) and a second service bus could be optimized for capability (e.g., guaranteed message delivery). Further, the SOA implementation could use different service bus technologies for the different service buses. For example, the low latency service bus could be implemented using P2P technology to handle market data feeds and the like, and the capability service bus could be a broker-mediated service bus with persistent data storage to handle clearance services and the like. According to another configuration, the low latency service bus could be a hardware accelerated broker-mediated service bus with persistent data storage, and the capability service bus could be a non-accelerated broker-mediated service bus with persistent data storage. Additional configurations utilizing various combinations of service bus technologies are envisioned within the scope of the present invention.

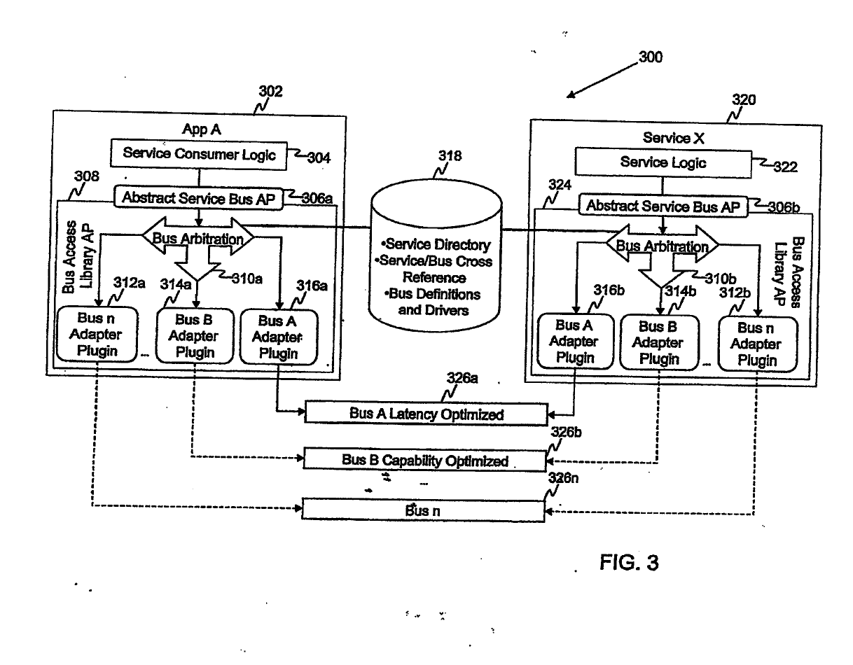

FIG. 3 is a detailed block diagram of an exemplary direct access multiple bus system 300, according to the present invention. More particularly, service logic 322 is an active software-based computing component that performs activities and/or provides information useful to the business process being automated. According to one embodiment of the present invention, the service logic related to a financial trading business process. For example, services may be related to trade analytics, trade execution, trade optimization, trade clearance, etc.

The service consumer logic 304 is a program that makes use of the business process provided by service logic 322. Electronic communication between the service consumer logic 304 and the service logic 322 must be established. This electronic communication is facilitated by interface components 308 and 324. Once electronic communication is established, service logic 322 can be accessed by a service consumer logic 304. Interface components are described in greater detail below.

The service logic 322 and the service consumer logic 304 are exposed to abstract bus application programming interfaces (APIs) 306b and 306a, respectively. Specifically, abstract bus API 306b provides the service logic 322 with a unified abstract view of multiple service buses 326a-n. The code of service logic 322 is not programmed to be accessed through a particular service bus or buses 326 a-n. Rather, at the time of deployment the decision is made as to which bus or buses 326a-n service logic 322 will be accessed through. The information pertaining to which bus or buses 326a-n service logic 322 will be accessed through is stored within service directory 318. Likewise, abstract bus API 306a provides the service consumer logic 304 with a unified abstract view of multiple service buses 326a-n. The code of service consumer logic 304 is not programmed access service logic 322 through a particular service bus or buses 326 a-n. Rather, at the time of accessing the information pertaining to which bus or buses 326a-n service logic 322 will be accessed through is accessed by the consumer service logic 304 from service directory 318. According to an embodiment of the present invention, for any given instance of accessing only one bus is used at a time. To illustrate this point, only the line connecting the Bus A Adapter Plugins 316a and 316b to Bus A 326a is solid, while the other possible connections (e.g., Bus B Adapter Plugins 314a and 314b to Bus B 326b is solid) are illustrated using a dotted line.

The bus arbitration components 310a and 310b route messages being exchanged between the service consumer logic 304 and the service logic 322 (and vice versa) to the appropriate service bus 326a-n for delivery. The routing is accomplished using information delivered to the arbitration components 310a and 310b from the service directory 318.

The service directory 318 contains information regarding service bus identification information cross-referenced with the available service logics in a directory that is accessible by the bus arbitration components 310a and 310b. This directory information allows the interface components 308 and 324 to make routing decisions. According to one embodiment of the present invention, the service location information is added to the service directory 318 at the time a service is deployed.

Service buses 326a-n are individually optimized for different characteristics, as discussed in detail above. According to the shown embodiment of the present invention, service bus 326a is a latency optimized service bus. For example, as discussed above, service bus 326a could be a service bus implemented using P2P technology. Service bus 326b is a capability optimized service bus. For example, as discussed above, service bus 326b could be a broker-mediated service bus with persistent data storage. Any number of additional service buses could be added to the shown embodiment of the present invention. These additional service buses can be individually optimized and may be implemented using the same or different technologies and/or protocols as service buses 326a and 326b.

Bus adaptor plug-ins for service bus A 316a and 316b are components, whose images is stored in the directory and delivered to the interface components 308 and 324 on demand. Bus adaptor plug-ins for service bus A 316a and 316b embody the specialized logic required to implement the abstract service bus APIs' 306a and 306b functionality in terms of the technological implementation of service bus A 326. This logic may include such activities as protocol conversion or data translation. For example, various wire protocols can be used, such as TIBCO and speed router.

Similar bus adapter plug-ins are used for service buses B-n. The bus adapter plug-ins for service bus B 326b are 314a and 314b. The bus adapter plug-ins for service bus n 326n are 312a and 312b.

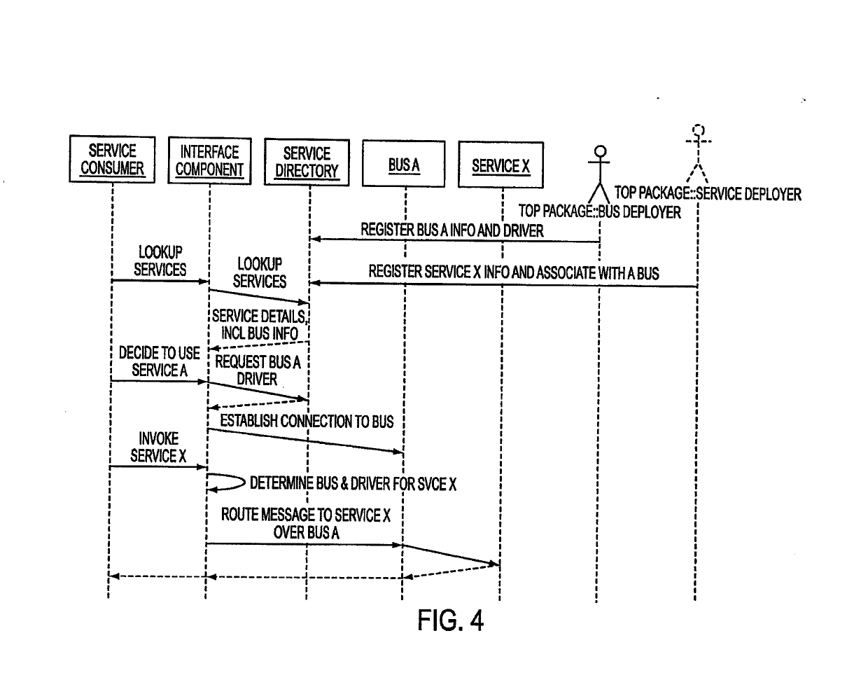

FIG. 4 is a flow diagram showing the operation of an exemplary direct access multiple bus system. Specifically, FIG. 4 illustrates, at a high level, the registration of service bus A for use in the SOA by the Bus Deployer. Also shown is the registering of service X, and the association of service X with a service bus, by the Service Deployer. Both registrations are made to the service directory, which is discussed in detail above. The remainder of the flow diagram illustrates the steps taken by a service consumer to access a service, e.g., service X. First, the service consumer performs a lookup for a given service. This request is mediated by the interface component which accesses the service directory. The service directory returns the necessary access information to the interface component. Next, when the service consumer actually initiates the use of service X, a request is made by the interface component to the service directory for the service bus A driver. The driver is returned to the interface component, which then establishes a connection to service bus A. The service consumer then invokes service X. The appropriate service bus and driver for service X is determined at the interface component, which in turn routes the message to service X over service bus A. Then a message from service X is returned, via service bus A, to the service consumer.

The invention being thus described, it will be apparent to those skilled in the art that the same may be varied in many ways without departing from the spirit and scope of the invention. For example, one of ordinary skill in the art will readily understand that the system can be implemented over local area networks and/or wide area networks, such as the Internet or an intranet, using a client server, a centralized server, distributed servers, etc. Also, while the direct access multiple bus arbitration system and method according to the present invention was developed to optimize access to electronically delivered financial trading services, it can be applied more generally to improve access to other types of electronically delivered services. Any and all such modifications are intended to be included within the scope of the invention.

1. A computer-implemented method for providing access to financial trading services, comprising:
identifying financial trading services that will be accessible to an end user;
determining performance requirements for each financial trading service, wherein the performance requirements relate to at least one of latency and reliability for each financial trading service;
creating, by a computer, at least a first service bus and a second service bus, wherein the first and second service buses have performance characteristics related to at least one of latency and reliability, and wherein a performance characteristic of the first service bus differs from a performance characteristic of the second service bus;
determining a first group of financial trading services that will be accessible via the first service bus and a second group of financial trading services will be accessible via the second service bus; and
attaching, by the computer, the first group of financial trading services to the first service bus and the second group of financial trading services to the second service bus.

2. The method of claim 1, wherein the financial trading services include at least one of trade order analytics, trade order routing, trade order processing, trade order clearance, and market data feeds.

3. The method of claim 1, wherein the first service bus is one of a broker-mediated service bus, a broker-mediated service bus with persistent data storage, and a peer-to-peer service bus.

4. The method of claim 1, wherein the first and second service buses are of a same service bus type.

5. The method of claim 1, wherein the first and second service buses are of a different service bus type.

6. The method of claim 1, wherein the step of determining which financial trading services will be accessible via the first service bus and which financial trading services will be accessible via the second service bus further includes:
assigning the financial trading services to the first and second service buses based at least in part on the performance requirements of each financial trading service and the performance characteristics of the first and second service buses.

7. The method of claim 1, further comprising a step of providing access to said financial trading services via the first and second service buses.

8. The method of claim 1, wherein the computer comprises one or more computers.

9. A method for accessing financial trading services, comprising the following steps:
receiving, by a computer, a first financial trading service request message via a first service bus with a first performance characteristic and a second financial trading service request message via a second service bus with a second performance characteristic that differs from the first performance characteristic, wherein the first and second financial trading service request messages were generated by a financial trading service consumer and routed via an interface component; and
sending, by the computer, the received first financial trading service request message to a first financial trading service that is connected to the first service bus and the received second financial trading service request message to a second financial trading service that is connected to the second service bus.

10. The method of claim 9, wherein the interface component routed the financial trading service request message using information gained by accessing a service directory database.

11. The method of claim 9, wherein the interface component is connected to at least a second service bus.

12. The method of claim 11, wherein the service bus and the second service bus are of a same service bus type.

13. The method of claim 11, wherein the service bus and the second service bus are of a different service bus type.

14. The method of claim 11, wherein the service bus is a broker-mediated service bus, a broker-mediated service bus with persistent data storage, or a peer-to-peer service bus.

15. The method of claim 11, wherein the second service bus is a broker-mediated service bus, a broker-mediated service bus with persistent data storage, or a peer-to-peer service bus.

16. A computerized system for accessing financial trading services, comprising:
a first plurality of financial trading services;
a second plurality of financial trading services;
first and second service buses configured to receive financial trading service request messages;
wherein the first plurality of financial trading services are attached to the first service bus and the second plurality of financial trading services are attached to the second service bus;
wherein the first and second service buses have performance characteristics related to at least one of latency and reliability, and wherein a performance characteristic of the first service bus differs from a performance characteristic of the second service bus; and
wherein the received financial trading service request messages are routed by an integration component configured to route the financial trading service request messages to one of the first and second service buses.

17. The system of claim 16, wherein the interface component is configured to route the financial trading service request message using information gained by accessing a service directory database.

18. The system of claim 16, wherein the two or more service buses are of a same service bus type.

19. The system of claim 16, wherein the two or more service buses are of a different service bus type.

20. The system of claim 17, wherein the two or more service buses are a broker-mediated service bus, a broker-mediated service bus with persistent data storage, or a peer-to-peer service bus.
